(19) United States
(12) Patent Application Publication
(10) Pub. No.: US 2025/0278591 A1
(43) Pub. Date: Sep. 4, 2025

(54) NON-TRANSITORY RECORDING MEDIUM, DOCUMENT-DATA MERGING SYSTEM, AND DOCUMENT-DATA MERGING METHOD

(71) Applicant: Yasuhito Horiguchi, TOKYO (JP)

(72) Inventor: Yasuhito Horiguchi, TOKYO (JP)

(73) Assignee: Ricoh Company, Ltd., Tokyo (JP)

(21) Appl. No.: 19/051,578

(22) Filed: Feb. 12, 2025

(30) Foreign Application Priority Data
Feb. 29, 2024 (JP) 2024-030066

(51) Int. Cl. G06K 15/02; G06F 16/353; G06F 40/174

(52) U.S. Cl. CPC G06K 15/1893; G06F 16/353; G06F 40/174

(57) ABSTRACT

A non-transitory recording medium storing a program which, when executed by one or more processors, causes the one or more processors to a method. The method includes acquiring a plurality of document data from a memory that stores the plurality of document data. The method includes classifying the plurality of document data based on a merge rule. The method includes merging two or more document data classified to generate merged document data.

### CROSS-REFERENCE TO RELATED APPLICATIONS

This patent application is based on and claims priority pursuant to 35 U.S.C. § 119(a) to Japanese Patent Application No. 2024-030066, filed on Feb. 29, 2024, in the Japan Patent Office, the entire disclosure of which is hereby incorporated by reference herein.

### BACKGROUND

### Technical Field

The present disclosure relates to a non-transitory recording medium, a document-data merging system, and a document-data merging method.

### Related Art

It is desired to manage document data related to a task such as a project, such as drawings and related documents, in units of the project. The document data related to the project may be a design drawing of a building managed at a design office for the building, and a design drawing of a product managed at a manufacturer of the product.

The document data may be further distributed to a department or a person who needs the document data.

A technique has been proposed for reducing a load when a management department distributes the document data. For example, a configuration of a drawing-output management system that manages a distribution destination of a drawing and a drawing management system that manages a drawing to be distributed have been proposed.

### SUMMARY

The present disclosure described herein provides a non-transitory recording medium storing a program which, when executed by one or more processors, causes the one or more processors to a method. The method includes acquiring a plurality of document data from a memory that stores the plurality of document data. The method includes classifying the plurality of document data based on a merge rule. The method includes merging two or more document data classified to generate merged document data.

The present disclosure described herein provides a document-data merging system. The document-data merging system includes a server, and an information processing apparatus communicably connected with the server via a network. The server includes server circuitry. The server circuitry acquires a plurality of document data from a memory that stores the plurality of document data. The server circuitry classifies the plurality of document data based on a merge rule. The server circuitry merges two or more document data classified to generate merged document data. The information processing apparatus includes apparatus circuitry. The apparatus circuitry receives the merged document data from the server.

The present disclosure described herein provides a document-data merging method performed by one or more computers. The method includes acquiring a plurality of document data from a memory that stores the plurality of document data. The method includes classifying the plurality of document data based on a merge rule. The method includes merging two or more document data classified to generate merged document data.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an outline of registration of document data;

FIG. 2 is a diagram of a system configuration of a document-data merging system;

FIG. 3 is a diagram illustrating a hardware configuration of a server apparatus, a document generation terminal, and a document registration terminal;

FIG. 4 is a block diagram illustrating a hardware configuration of an image forming apparatus, which is an example of an apparatus;

FIG. 5 is a diagram illustrating a functional configuration of a document-data merging system;

FIG. 6 is a diagram illustrating a merge rule stored in a merge-rule storage unit;

FIG. 7 is a diagram illustrating classification information stored in a classification-information storage unit;

FIG. 8 is a diagram illustrating a document-data registration screen displayed by a document registration terminal;

FIG. 9 is a sequence diagram illustrating a process of merging document data by a document-data merging system;

FIGS. 10A and 10B are flowcharts illustrating a process in which a document registration terminal classifies and merges document data;

FIG. 11 is a diagram illustrating a document-data registration screen which displays one or more document data classified into each classification destination;

FIG. 12 is a diagram illustrating an error message displayed when a required document is not found;

FIG. 13 is a flowchart when the document registration terminal performs a merge process at predetermined time intervals;

FIG. 14 is a flowchart when the document registration terminal performs a merge process before print due date and time;

FIG. 15 is a functional block diagram of a document-data merging system according to a client-server type; and

FIG. 16 is a sequence diagram illustrating a process of merging document data by a document-data merging system according to a client-server type.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A document-data merging system and a document-data merging method performed by the document-data merging system are described below as an example of an embodiment of the present disclosure with reference to the drawings.

### Overview of Registration of Document Data

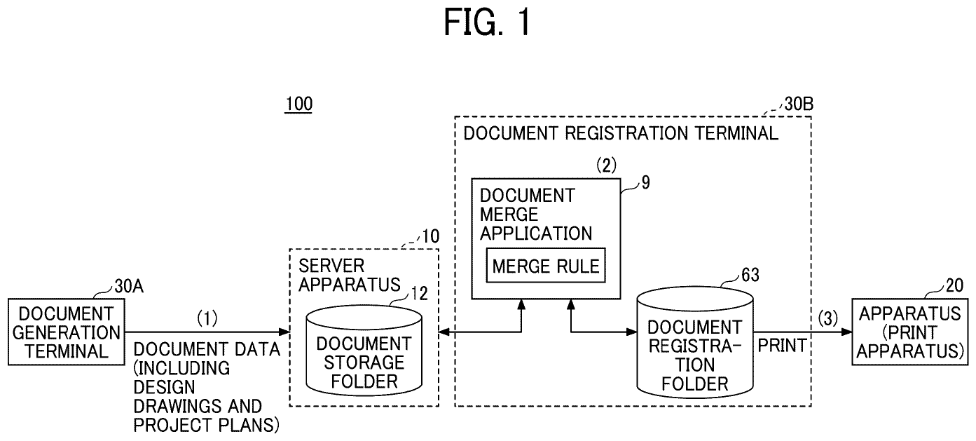

FIG. 1 is a diagram illustrating an overview of registration of document data.
(1) A document writer operates a document generation terminal 30A to store, in a document storage folder 12, document data such as a design drawing or a plan document relating to a task such as a project. The document storage folder 12 is provided in, for example, a server apparatus 10 or a network attached storage on a network.
(2) A document merge application 9 is installed in a document registration terminal 30B in advance. A person in charge of document registration who merges and distributes documents operates the document registration terminal 30B to execute the document merge application 9. The document merge application 9 acquires document data from the document storage folder 12 to classify the document data in the document storage folder 12 based on a merge rule. For example, the merge rule classifies the document data based on the file name of the document data.
(3) The document merge application 9 merges one or more document data classified into the same classification destination to register the merged document data in a document registration folder 63. The document merge application 9 generates the document registration folder 63 associated with the project when the document data is registered.

### Term

As described above, in the present embodiment, a document writer of, for example, a design drawing or a plan document may accumulate generated document data in the document storage folder 12. When the person in charge of document registration operates the document merge application 9 (or may not operate the document merge application 9), the document merge application 9 merges the document data to be integrated into one document data and registers the merged document data in the document registration folder 63. The document registration terminal 30B may automatically print the merged document data or may print the merged document data at any selected timing. The document registration terminal 30B may distribute the merged document data.

Therefore, the document-data merging system 100 according to the present embodiment reduces a workload related to registration and distribution of the document data.

A project is a series of tasks that are performed in a planned manner to achieve a specific goal. In a project, a goal or a product to be achieved within a specific period may be set. Although the project may be performed by an individual, basically, a plurality of members are involved in the same project, and each member executes a task extracted to achieve one goal. In the process of the project, a large amount of document data is generated. The present embodiment relates to distribution of document data generated in this project.

The document data is electronic data (hereinafter, referred to as “document data”) in which a document is recorded. A document is a collection of one or more words or sentences (and may of course include other multiple languages such as alphanumeric characters). The document data may be data in any format as long as the data can express a sentence. For example, the document data may be data representing a document in a text format or data in a format specialized for a specific application. Alternatively, the document data may be data representing a word or a sentence itself or a concept corresponding to the word or the sentence by, for example, an image, a sound, or a video (moving image). Accordingly, the document data may be image data, audio data, or video data. Further, the storage format of the document data is not limited to a specific format. For example, the document data may be stored in a file, may be stored as a record in a database, or may be stored in another format.

The document data may be data used for a task, such as an in-house document (a PDF file or an application file) or minutes of an in-house conference, or may be personal document data such as a web page or an image of a hobby.

The information that can be referred to in the document data is information included in the document data. For example, the document data has a file name and document contents. The document data has, for example, a file size, a time stamp, and a writer as attributes. In the present embodiment, the file name is searched for merging, but any information that can be referred to in the document data may be searched.

A document storage unit is a storage unit in which a plurality of document data before being merged are stored.

In the present embodiment, the document storage unit is described as a term “document storage folder 12.” A document registration unit is a storage unit in which the merged document data is registered. In the present embodiment, the document registration unit is described as a term “document registration folder 63.”

Merging is to combine a plurality of document data into one document data. For example, when the document data A includes page 1 to page 3 and the document data B includes page 1 to page 5, the document data A and the document data B are merged to generate one document data including page 1 to page 8. The file name of the merged document data may be, for example, “classification destination name”+“date,” which will be described later.

Classifying a plurality of document data means sorting the plurality of document data into a plurality of classification destinations according to a predetermined rule. In the present embodiment, the rule is referred to as a merge rule. The rule is generated so that, for example, document data in the same category is classified into the same classification destination or is classified into the same print size for easy handling. The category varies based on the project, and for example, in the case of a building project, examples of the category include a category relating to interior, a category relating to exterior, a category relating to windows, and a category relating to exterior walls. In this case, since the document data related to the interior is merged into one, it is possible to reduce the workload of the person in charge of document registration to merge the document data related to the interior. For example, in the case of a product development project, examples of the category include a category related to a UI of the liquid crystal panel, a category related to an appearance design, a category related to a function, and a category related to a cost calculation.

### First Embodiment

### Example of System Configuration

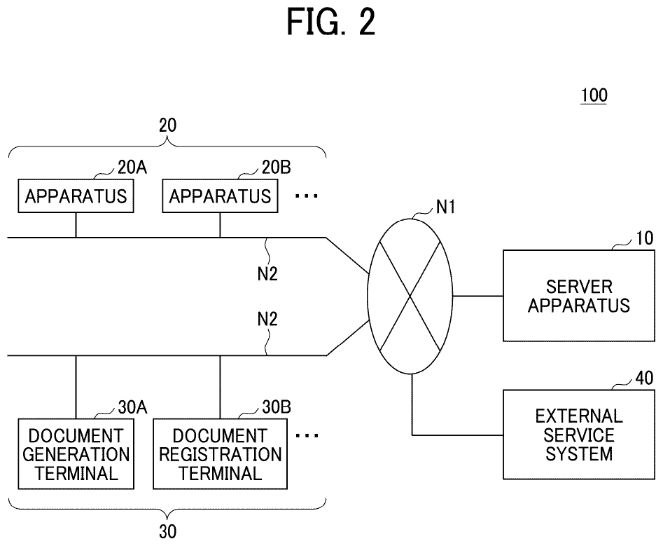

FIG. 2 is a system configuration diagram of an example of a document-data merging system 100. The document-data merging system 100 includes a server apparatus 10, a document generation terminal 30A, a document registration terminal 30B, and an apparatus 20. The server apparatus 10 and the apparatus 20 are connected to each other via a wide area network N1 such as the Internet so as to communicate with each other. The server apparatus 10, the document generation terminal 30A, and the document registration terminal 30B are connected to each other via the wide area network N1 such as the Internet so as to communicate with each other. The server apparatus 10, the apparatus 20, the document generation terminals 30A, and the document registration terminal 30B communicate with an external service system 40, which is an external system, via the network N1. The apparatus 20, the document generation terminal 30A, and the document registration terminal 30B are installed in a facility, for example, a company and are connected to a network N2. The network N2 may be a local area network (LAN), WI-FI, wide-area ETHERNET, or a fourth generation (4G), fifth generation (5G), or sixth generation (6G) mobile network. The document generation terminal 30A and the document registration terminal 30B may be located outside the company or may be carried by users.

The server apparatus 10 includes a document storage folder 12. The server apparatus 10 is implemented by one or more information processing apparatuses, and provides various services implemented by a series of processes in cooperation with the external service system 40 such as a cloud service via the network N1. As will be described later, the server apparatus 10 may execute, for example, merging of document data. The server apparatus 10 may be implemented by cloud computing or may be implemented by a single information processing apparatus. The term “cloud computing” refers to the availability of resources on a network without identifying specific hardware resources. The server apparatus 10 may be present on the Internet or may be present on-premises.

The apparatus 20 is any of various electronic devices used by a user. In the present embodiment, the apparatus 20 may have a function of printing the document data (print function). Such apparatus 20 may be referred to as, for example, an image processing apparatus, an image forming apparatus, a multifunction peripheral (MFP), a printing apparatus, or a printer. The apparatus 20 is used for printing document data transmitted from the document registration terminal 30B for, e.g., distribution. The apparatus 20 may have a scanner function of optically reading a document. In this case, the image data scanned by the apparatus 20 may also be registered in the server apparatus 10.

Further, in the apparatus 20, a web browser may be used. The user can use various services (applications) provided by the document registration terminal 30B or the server apparatuses 10 by connecting the apparatus 20 to the document registration terminal 30B or the server apparatus 10 via the web browser. For example, the user may have the apparatus 20 display a list of the merged document data, and may have the apparatus 20 download and print the document data (pull print printing).

In the following description, when the plurality of apparatuses 20 are distinguished from each other, the apparatuses 20 are described using suffixes such as “apparatus 20A” and “apparatus 20B.”

The document generation terminal 30A and the document registration terminals 30B are information processing devices used by users. The document generation terminals 30A is used by the document writer to generate document data, acquire document data from outside the document generation terminals 30A, or edit document data. The document registration terminal 30B is used by the person in charge of document registration to merge or print document data. The document registration terminal 30B transmits the merged document data to the apparatus 20 in response to an operation by the user or automatically.

Examples of the document generation terminal 30A and the document registration terminal 30B include, but not limited to, a personal computer (PC), a tablet terminal, a smartphone, a wearable PC, or a personal digital assistant (PDA). In addition, the document generation terminal 30A and the document registration terminal 30B may run a web browser or a dedicated application. For example, the document generation terminal 30A may be an electronic blackboard, and a screen displayed on the electronic blackboard may be converted into, for example, a PDF and transmitted to the server apparatus 10. The document generation terminal 30A and the document registration terminal 30B may be, for example, head-up display (HUD) devices, industrial machines, imaging devices, sound collection devices, medical devices, network home appliances, car navigation systems, game machines, digital cameras, or wearable PCs.

In the present embodiment, a case where the document registration terminal 30B executes native applications will be described, but the document generation terminal 30A and the document registration terminal 30B may execute web applications provided by the server apparatus 10. The web application is defined as software or a mechanism of software that is implemented by cooperation between a program executed on a browser and written in a programming language such as JAVASCRIPT and a program provided by a web server.

The web application for the document registration terminal 30B to register document data displays a list of classified document data, a list of merged document data, and the contents of the merged document data.

The external service system 40 is one or more information processing apparatuses that provide a service by storing, reading, or processing data when the server apparatus 10 executes a web application. In the present embodiment, the external service system 40 may not be used. The merged document data may be registered in the external service system 40. The “outside” of the external service system 40 means a system different from the server apparatus 10, but may not be operated by a company different from the server apparatus 10. For example, even if the users are the same, the account of the external service system 40 may be different from the account of the server apparatus 10.

Examples of the external service system 40 include a cloud service and an application service provider (ASP). The external service system 40 may provide various external services provided via a network. For example, examples of the service include providing a storage service. The external service system 40 may be located on the Internet or on-premises.

### Hardware Configuration

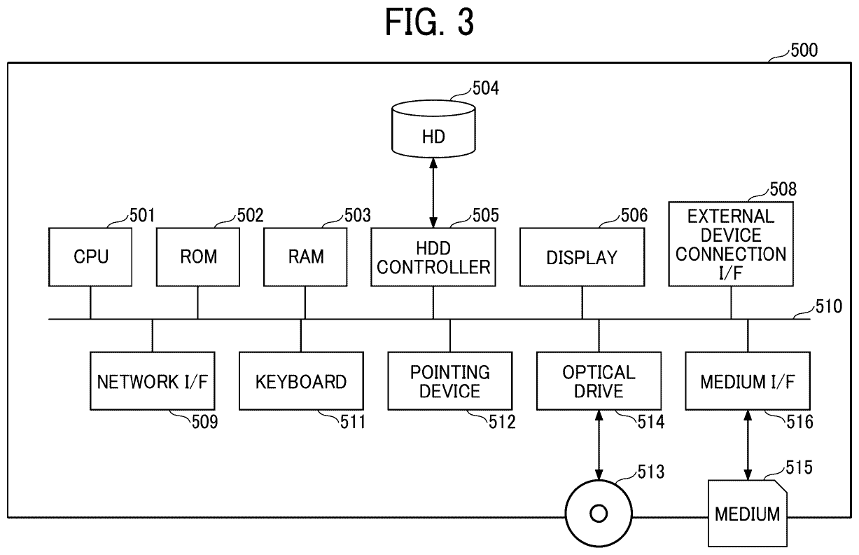

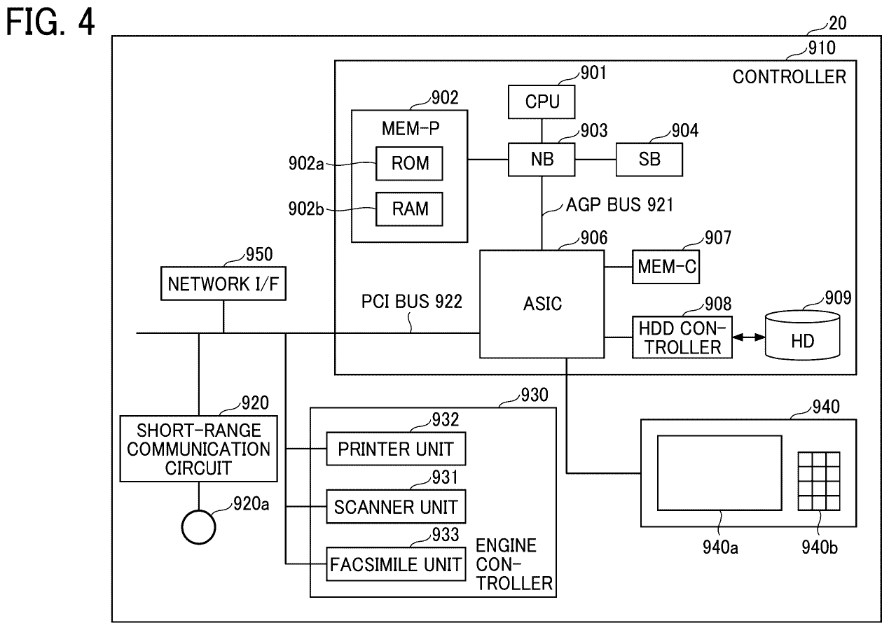

A hardware configuration of the server apparatus 10, the document generation terminal 30A, and the document registration terminal 30B included in the document-data merging system 100 according to the present embodiment will be described with reference to FIG. 3 and FIG. 4.

Server Apparatus, Document Generation Terminal, and Document Registration Terminal

FIG. 3 is a diagram illustrating an example of a hardware configuration of the server apparatus 10, the document generation terminal 30A, and the document registration terminal 30B according to the present embodiment. As illustrated in FIG. 3, each of the server apparatus 10, the document generation terminal 30A, and the document registration terminal 30B is implemented by a computer 500, and include a central processing unit (CPU) 501, a read-only memory (ROM) 502, a random-access memory (RAM) 503, a hard disk (HD) 504, an HD drive (HDD) controller 505, a display 506, an external device connection interface (I/F) 508, a network I/F 509, a bus line 510, a keyboard 511, a pointing device 512, a digital versatile disc-rewritable (DVD-RW) drive 514 as an optical drive, and a medium I/F 516.

The CPU 501 controls the entire operation of the computer 500. The ROM 502 stores programs used for driving the CPU 501, such as initial driving load (IPL). The RAM 503 is used as a work area for the CPU 501. The HD 504 stores various data such as a program. The HDD controller 505 controls reading or writing of various data from or to the HD 504 under control of the CPU 501. The display 506 displays various kinds of information such as a cursor, a menu, a window, characters, or an image. The external device connection I/F 508 is an interface for connecting to various external devices. Examples of the external devices include, but are not limited to, a universal serial bus (USB) memory and a printer.

The network I/F 509 is an interface for performing data communication using the network N1 or the network N2. The bus line 510 is, for example, an address bus or a data bus for electrically connecting the components such as the CPU 501 illustrated in FIG. 3 with each other.

The keyboard 511 is a kind of input device including multiple keys used for inputting items such as characters, numerical values, or various instructions. The pointing device 512 is a kind of input device used to, for example, select various instructions, execute various instructions, select a target for processing, and move a cursor. The DVD-RW drive 514 reads and writes various data from and to a DVD-RW 513 which is an example of a removable recording medium. The DVD-RW drive 514 is not limited to the drive for DVD-RWs and may be, for example, a drive for a digital versatile disc-recordable (DVD-R). The medium I/F 516 controls reading and writing (storing) of data from and to a storage medium 515 such as a flash memory.

### Apparatus

FIG. 4 is a block diagram illustrating an example of a hardware configuration of an image forming apparatus, which is an example of the apparatus 20. As illustrated in FIG. 4, the image forming apparatus includes a controller 910, a short-range communication circuit 920, an engine controller 930, an operation panel 940, and a network interface I/F 950.

The controller 910 includes a CPU 901 as a main processor, a system memory (MEM-P) 902, a north bridge (NB) 903, a south bridge (SB) 904, an application-specific integrated circuit (ASIC) 906, a local memory (MEM-C) 907, an HDD controller 908, and an HD 909 as a storage device. The NB 903 and the ASIC 906 are connected through an accelerated graphics port (AGP) bus 921.

The CPU 901 controls the entire operation of the image forming apparatus. The NB 903 connects the CPU 901 to the MEM-P 902, the SB 904, and the AGP bus 921. The NB 903 includes a memory controller that controls reading or writing of various data from or to the MEM-P 902, a peripheral component interconnect (PCI) master, and an AGP target.

The system memory 902 includes a ROM 902a and a RAM 902b. The ROM 902a stores data and program for implementing various functions of the controller 910. The RAM 902b is used to load the program and the data. The RAM 902b is also used as a memory for loading drawing data for printing. The program stored in the RAM 902b may be stored in any computer-readable storage (recording) medium, such as a compact disc-read only memory (CD-ROM), a compact disc-recordable (CD-R), or a DVD, in a file format installable or executable by the computer, for distribution.

The SB 904 is a bridge that connects the NB 903 with a PCI device or a peripheral device. The ASIC 906 is an integrated circuit (IC) dedicated to an image processing use, and connects the AGP bus 921, a PCI bus 922, the HDD controller 908, and the MEM-C 907. The ASIC 906 includes a PCI target, an AGP master, an arbiter (ARB) as a core of the ASIC 906, a memory controller for controlling the MEM-C 907, a plurality of direct memory access controllers (DMAC) for performing image rotation by hardware logic, and a PCI unit for performing data transmission with a scanner unit 931, a printer unit 932, and a facsimile unit 933 via the PCI bus 922. The ASIC 906 may have a USB interface, or the Institute of Electrical and Electronics Engineers 1394 (IEEE1394) interface.

The MEM-C 907 is a local memory used as a buffer for image data to be copied or a code buffer. The HD 909 is a storage (memory) that stores various image data, font data for printing, and form data. The HDD 908 reads or writes various data from or to the HD 909 under control of the CPU 901. The AGP bus 921 is a bus interface for a graphics accelerator card, which has been proposed to accelerate graphics processing. Through directly accessing the MEM-P 902 by high-throughput, the speed of the graphics accelerator card increases.

The short-range communication circuit 920 is provided with a short-range communication antenna 920a. The short-range communication circuit 920 is a communication circuit that communicates in compliance with a near field communication (NFC) or the BLUETOOTH, for example.

The engine controller 930 includes the scanner unit 931, the printer unit 932, and the facsimile unit 933. The operation panel 940 includes a panel display 940a and a hard key 940b. The panel display 940a is implemented by, for example, a touch panel that displays current settings or a selection screen to receive a user input. The hard key 940b includes a numeric keypad that receives set values of various image forming parameters such as an image density parameter and a start key that receives an instruction for starting copying. The controller 910 controls the entire operation of the image forming apparatus and controls, for example, drawing, communication, and input from the operation panel 940. The scanner unit 931 and the printer unit 932 each performs various image processing, such as error diffusion or gamma conversion.

In response to an instruction to select a specific application through the operation panel 940, for example, using a mode switch key, the image forming apparatus selectively performs a document box function, a copier function, a printer function, and a facsimile function. When the document box function is selected, the image forming apparatus operates in a document box mode. When the copier function is selected, the image forming apparatus operates in a copy mode. When the printer function is selected, the image forming apparatus operates in a printer mode. When the facsimile function is selected, the image forming apparatus operates in a facsimile mode.

The network I/F 950 is an interface for performing data communication using the network N2. The short-range communication circuit 920 and the network I/F 950 are electrically connected to the ASIC 906 via the PCI bus 922.

### Function

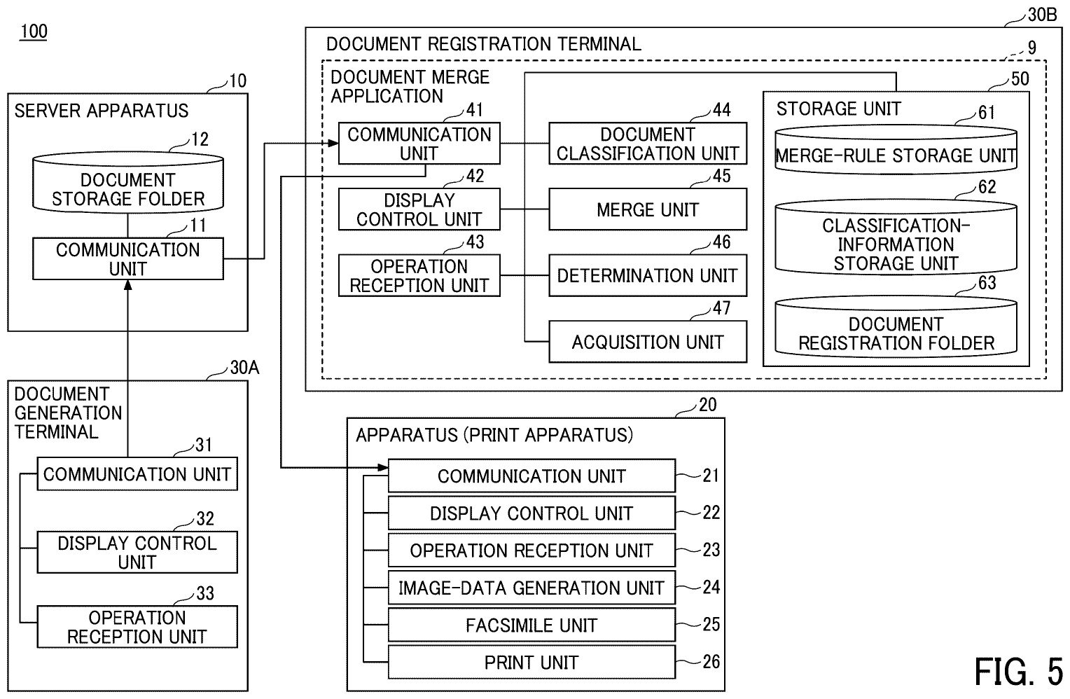

A functional configuration of the document-data merging system 100 is described below with reference to FIG. 5. FIG. 5 is a diagram illustrating an example of the functional configuration of the document-data merging system 100 according to the present embodiment.

### Document Generation Terminal

The document generation terminal 30A includes a communication unit 31, a display control unit 32, and an operation reception unit 33.

These functional units provide functions or means implemented by the CPU 501 illustrated in FIG. 3 executing instructions included in one or more programs installed on the document generation terminal 30A.

For example, the communication unit 31, the display control unit 32, and the operation reception unit 33 may be implemented by a web browser or a dedicated application (native application).

The communication unit 31 transmits and receives various kinds of information to and from the server apparatus 10. The communication unit 31 transmits the document data to the server apparatus 10 by, for example, a server message block (SMB) or a file transfer protocol (FTP).

The display control unit 32 interprets screen information of various screens to display screens on the display 506.

The operation reception unit 33 receives various operations made by the user on various screens displayed on the display 506.

### Server Apparatus

The server apparatus 10 includes a communication unit 11 and a document storage folder 12. The functional units of the server apparatus 10 provide functions or means implemented by the CPU 501 illustrated in FIG. 3 executing instructions included in one or more programs installed in the server apparatus 10. The document storage folder 12 is built in, for example, the RAM 503 or the HD 504 illustrated in FIG. 3.

The communication unit 11 transmits and receives various kinds of information between the document generation terminal 30A and the document registration terminal 30B. In the present embodiment, the communication unit 11 receives, for example, the document data from the document generation terminal 30A.

The communication unit 11 transmits the list of the document data and the document data themselves to the document registration terminal 30B in response to a request from the document registration terminal 30B.

The document storage folder 12 is a folder for storing the document data received by the communication unit 11. Although the document storage folder 12 is illustrated as a single folder, the document storage folder 12 is a generic term, and the document data may be stored in a lower folder in the document storage folder 12. All the document data may be stored in one folder.

### Document Registration Terminal

The document registration terminal 30B includes a communication unit 41, a display control unit 42, an operation reception unit 43, a document classification unit 44, a merging unit 45, a determination unit 46, an acquisition unit 47, and a storage unit 50. The functional units of the document registration terminal 30B provide functions or means implemented by the CPU 501 illustrated in FIG. 3 executing instructions included in one or more programs (e.g., the document merge application 9) installed in the server apparatus 10. The storage unit 50 is built in, for example, the RAM 503 or the HD 504 illustrated in FIG. 3. The storage unit 50 may be built on a network that can be accessed by the document registration terminal 30B or the apparatus 20, instead of the document registration terminal 30B.

The communication unit 41 transmits and receives various kinds of information to and from the server apparatus 10 and the apparatus 20. In the present embodiment, the communication unit 41 receives the list of the document data and the document data themselves from the server apparatus 10. The communication unit 41 transmits and receives various kinds of information to and from the apparatus 20. In the present embodiment, the communication unit 41 transmits the merged document data to the apparatus 20. Alternatively, the communication unit 41 transmits the list of the merged document data to the apparatus 20, and transmits the document data requested by the apparatus 20 to the apparatus 20. In this case, the web application is executed on the apparatus 20, the web application displays the list of the document data, and the user selects document data to be printed.

The display control unit 42 is a unit that displays an error message when the document classification unit 44 cannot acquire all the document data that are the required documents in accordance with a search key. The display control unit 42 is a unit that displays the file names of the plurality of document data classified for each merge rule by the document classification unit 44 based on the merge rule in the area associated with the classification destination. Specifically, the display control unit 42 displays the document-data registration screen 200 included in the document merge application 9 on the display 506. Since the document merge application 9 is a native application, the configuration of the document-data registration screen 200 is included in the document merge application 9. The display control unit 42 displays a list of, for example, the document data the document-data registration screen 200.

The operation reception unit 43 is a unit that receives identification information of a task to which a plurality of document data is related. Specifically, the operation reception unit 43 receives various operations by the user on the document-data registration screen 200 displayed on the display 506.

The document classification unit 44 is a unit that classifies, based on the merge rule, the plurality of document data acquired by the acquisition unit 47. Specifically, the document classification unit 44 classifies a plurality of document data acquired from the document storage folder 12 of the server apparatus 10 based on the merge rule. The document classification unit 44 notifies the merge unit 45 of the plurality of classified document data.

The merging unit 45 is a unit that merges one or more document data classified by the document classification unit 44 to generate merged document data. The merged document data is one or more document data that have been merged. Specifically, the merge unit 45 merges a plurality of document data to register the merged data in the document registration folder 63. The merge unit 45 generates a folder (a lower folder of the document registration folder 63) associated with the project when the document data is registered, to register the merged document data in the generated folder. In the present embodiment, a folder having identification information of a project (an example of the identification information of the task) as a folder name is generated under the document registration folder 63. The identification information of the project is referred to as “ID.”

The determination unit 46 mainly performs two determinations. The determination unit 46 determines whether the number of one or more document data classified as the classification destination has reached a predetermined merge number. The classification destination means that document data having the same category or print size is classified into the same classification destination. The determination unit 46 determines whether all the required documents have been acquired in accordance with a file search key for each classification destination.

The acquisition unit 47 is a unit that acquires a plurality of document data from a document storage unit (document storage folder 12) that stores the plurality of document data.

Specifically, the acquisition unit 47 acquires a list of a plurality of document data or the plurality of document data themselves from the document storage folder 12 storing the plurality of document data via the communication unit 41.

The storage unit 50 includes a merge-rule storage unit 61, a classification-information storage unit 62, and a document registration folder 63. The document registration folder 63 is a folder in which the merged document data is registered. Although the document registration folder 63 is illustrated as a single folder, the document registration folder 63 is a generic name, and the merged document data is stored in a lower folder in the document registration folder 63 for each project. More specifically, a folder name of the identification information (ID) of the project is generated, and the merged document data is stored in the folder name.

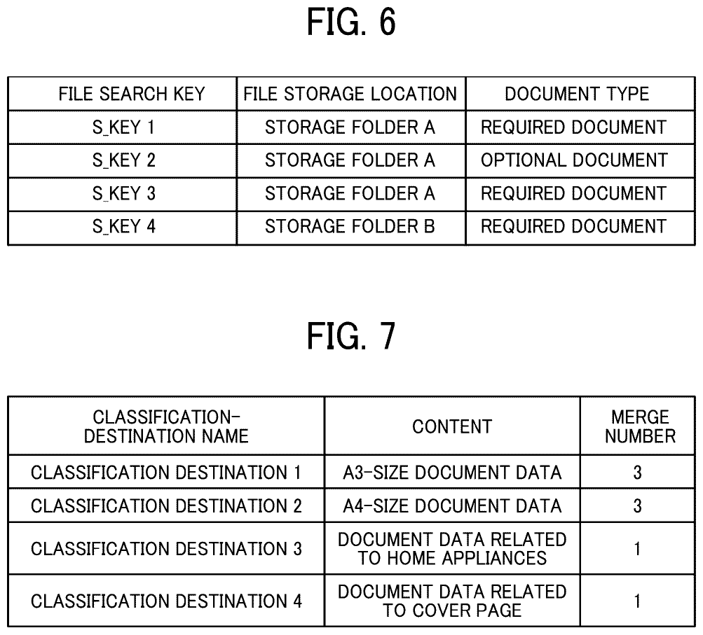

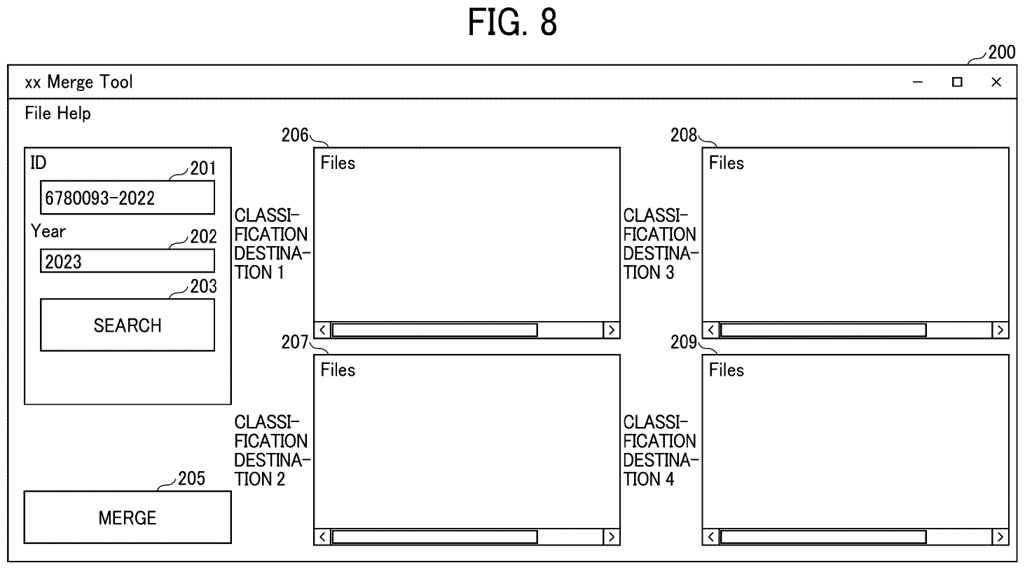

The merge-rule storage unit 61 and the classification-information storage unit 62 will be described with reference to FIG. 6 and FIG. 7.

### Apparatus

The apparatus 20 includes a communication unit 21, a display control unit 22, an operation reception unit 23, an image-data generation unit 24, a fax unit 25, and a print unit 26. These functional units provide functions or means implemented by the CPU 901 illustrated in FIG. 4 executing instructions included in one or more programs installed in the apparatus 20. For example, the communication unit 21, the display control unit 22, and the operation reception unit 23 are implemented by a web browser, and the other units are implemented by individual applications (native applications).

The communication unit 21 transmits and receives various kinds of information to and from the server apparatus 10. The communication unit 21 receives the document data. The communication unit 21 may receive screen information such as a document data list screen from the server apparatus 10 or the document registration terminal 30B, and may receive, for example, a requested document from the server apparatus 10 or the document registration terminal 30B.

The display control unit 22 interprets screen information of various screens and displays the screen information on the panel display 940a. The operation reception unit 23 receives various operations of the user on the various screens displayed on the panel display 940a.

When the application for which the operation reception unit 23 has received the selection is an application for generating image data, the image-data generation unit 24 reads (scans) a document by the scanner unit 931 to generate the image data. The image data is processed into document data such as a PDF file together with metadata.

The fax unit 25 performs processing related to reception and transmission of a facsimile by the facsimile unit 933, and requests the server apparatus 10 to execute an application associated in advance when the facsimile is received. The fax unit 25 may request an application corresponding to the transmission source (FAX number) of the facsimile.

The print unit 26 executes a print job instructed from the document registration terminal 30B. The print unit 26 prints a print job including the merged document data. The document data is printed on, for example, a sheet by executing the print job. The print unit 26 may also print the image data generated by the image-data generation unit 24.

### Merge Rule

FIG. 6 is a diagram illustrating the merge rule stored in the merge-rule storage unit 61. The merge rule defines a merge rule of the document data based on a file name. The file name is an example, and any information included in the document data may be used for classification. Since a plurality of classified document data, which may be zero or one, are merged into one document data, the merge rule is a rule for classifying and merging the document data. Of course, when the number of classified document data is zero, merging the document data is canceled.

The merge rule illustrated in FIG. 6 includes items of “file search key,” “file storage location,” and “document type.” One row (one record) illustrated in FIG. 6 is one search condition, and the entire FIG. 6 is one merge rule. One or more document data classified by the merge rule illustrated in FIG. 6 are classified into the same classification destination. One or more document data of the same classification destination are merged into one document data.

The file search key is a search key of the document data, and indicates that the document data including the file search key in the file name (or document data themselves) are classified into the classification destination (extracted from the document storage folder 12).

The file storage location is the folder name of the document storage folder 12 to be searched in accordance with the file search key. The file storage location may be, for example, a URL or a file path. Since the folder name of the document storage folder 12 to be searched is determined for each file search key, no trouble is caused even when document data prepared by a plurality of document writers have the same file name. A plurality of document writers may store document data in file storage locations that the document writers are in charge of. However, the file storage locations may not be classified as illustrated in FIG. 6. The document storage folder 12 has a folder name “ID+Year” as described later.

The document type indicates whether the document data searched in accordance with the file search key is required or optional for merging. The document type includes “required document” and “optional document.” The required document is document data required for merging, and the optional document is document data not required for merging. If at least one of the required documents does not match the file search key in one merge rule, it is determined to be an error, and the merge is not performed. If the optional document does not match the file search key, it is determined not to be an error, and the merge is performed.

In the case of the merge rule illustrated in FIG. 6, the document data matching the file search key “S_KEY 1,” the document data matching “S_KEY 2,” the document data matching “S_KEY 3,” and the document data matching “S_KEY 4” are merged into one document data. The optional document may not be required, but the required document is mandatory for merging. Since one of the objects of the present embodiment is to merge document data for each category or print size, a merge rule is prepared for each classification destination of the document data. As an example, the following classification destinations are assumed.

Classification destination 1, Classification destination 2, Classification destination 3, and Classification destination 4.

Therefore, one merge rule corresponds to one classification destination. Since the merge rule is prepared for each classification destination, there are four merge rules in FIG. 6 in total (three merge rules other than FIG. 6). The file search key may include a character string indicating a classification destination. In this case, the four merge rules are easily generated by adding a character string corresponding to the classification destination to the same file search key to generate a file search key. In this case, the document writer includes the classification destination in the file name of the document data.

The merge rule is preferably prepared for each piece of identification information for identifying a project. Accordingly, this makes it possible to differentiate the document type of the document specified by each file search key for each project. More specifically, when the term “S_KEY 1,” which is required for document data in one project, is optional in another project, the document type can be set in accordance with each project.

The document classification unit 44 refers to the merge rule prepared for each classification destination of the document data to extract the document data of the file name corresponding to each file search key of the merge rule from the document storage folder 12. It is expected that one or more document data are found for each classification destination. The document classification unit 44 classifies a plurality of document data into a plurality of classification destinations for each merge rule based on a plurality of merge rules having different classification destinations. Therefore, a plurality of document data are classified into the number of classification destinations (four in the present embodiment).

When the document data of the file name corresponding to the file search key cannot be extracted from the document storage folder 12, the determination unit 46 confirms the document type corresponding to the file search key and determines whether the document type is a required document. If the document type is a required document, the display control unit 42 notifies a document-extraction error.

### Classification Information

FIG. 7 is a diagram illustrating classification information stored in the classification-information storage unit 62. The classification information defines the content of the document data to be classified (i.e., merged) into each classification destination. The classification destination is determined according to the category or the print size of the document data. The content is, for example, a category or a print size. The classification information includes items of “classification destination name,” “content,” and “merge number.” One row (one record) illustrated in FIG. 7 represents one classification destination.

The item of the classification destination name is a name for the document merge application 9 to indicate the classification destination of the document data together with the document data suitable for the search.

The item of the content describes what document data is classified into the classification destination. The content items are illustrated for describing and are not used in the processing.

The merge number is the number of document data required for merging. The number of document data required for merging is determined for each classification destination, and an error occurs when the number of document data suitable for the search is less than the merge number. If the number of document data classified into one classification destination is more than the merge number, the classification destination may be permitted or determined to be an error. For example, when document data of a different version is generated, the document data is permitted, and otherwise, is determined to be an error.

Therefore, the document classification unit 44 can classify a plurality of document data having the same category into the same classification destination or classify a plurality of document data having the same print size into the same classification destination based on the file name of the document data.

### Document Data Registration Screen

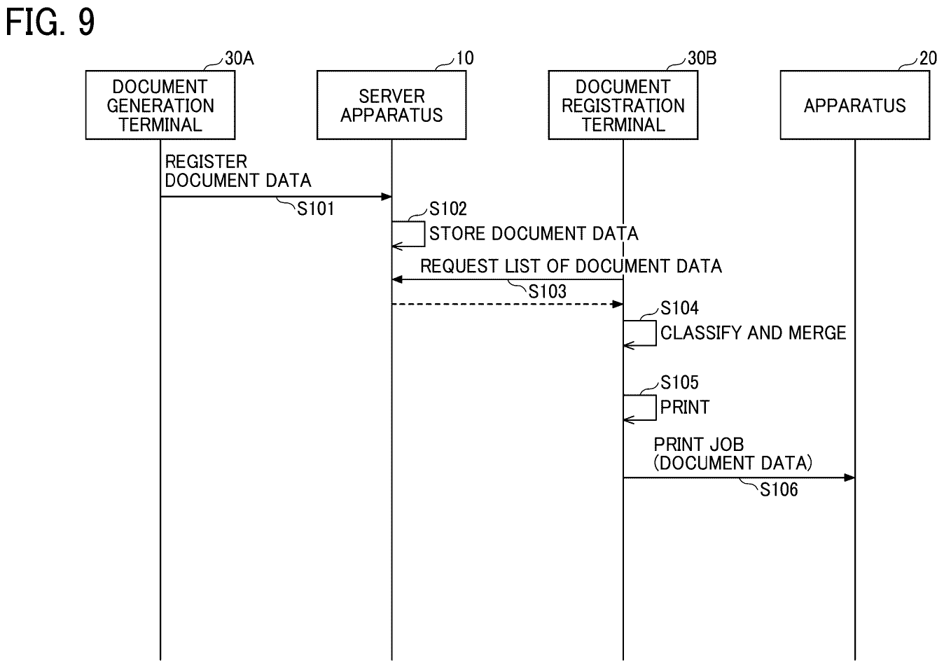

A user interface when the document registration terminal 30B registers a document data is described below with reference to FIG. 8. FIG. 8 illustrates a document-data registration screen 200 displayed by the document registration terminal 30B. Each item included in the document-data registration screen 200 is described.

ID 201 is the identification information of a project. The file name includes an ID and a file search key in advance. For example, in a case where the file name is “XXXX-S_KEY 1.pdf,” “XXXX” is the ID and “S_KEY 1” is the file search key. The user can designate document data to be extracted for merging by inputting the ID to the document-data registration screen 200. The ID is required, but is not required in an environment where there is only one project.

Year 202 is information for designating the folder name of the document storage folder 12. In the document storage folder 12, document data is stored in a folder whose folder name includes “ID+Year.”

A search button 203 is a button to be pressed by the person in charge of document registration to search and extract document data to be merged from the document storage folder 12.

A merge button 205 is a button to be pressed by the person in charge of document registration to merge one or more document data that matches the file search key and is classified as a classification destination.

The first area 206 is an area in which a list of the document data that matches the search in accordance with the merge rule corresponding to the first classification information (classification destination 1 illustrated in FIG. 8) is displayed.

The second area 207 is an area in which a list of the document data that matches the search in accordance with the merge rule corresponding to the second classification information (classification destination 2 illustrated in FIG. 8) is displayed.

The third area 208 is an area in which a list of the document data that matches the search in accordance with the merge rule corresponding to the third classification information (classification destination 3 illustrated in FIG. 8) is displayed.

The fourth area 209 is an area in which a list of the document data that matches the search in accordance with the merge rule corresponding to the fourth classification information (classification destination 4 in FIG. 8) is displayed.

### Operation or Processing

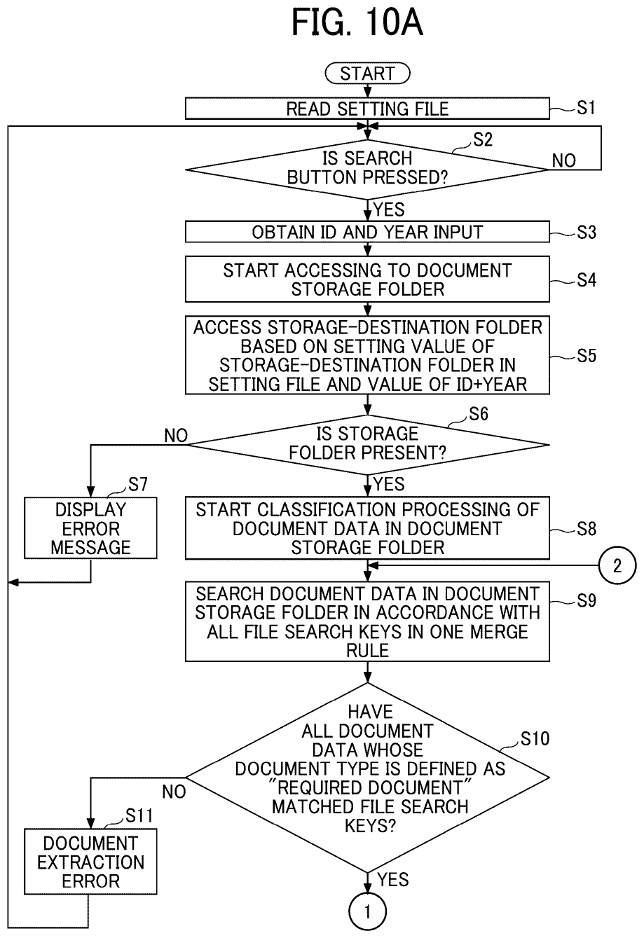

A flow of processing in which the document registration terminal 30B merges document datasets for each classification will be described with reference to FIG. 9. FIG. 9 is a sequence diagram illustrating a process of merging the document data performed by the document-data merging system 100.

In step S101, a document writer operates the document generation terminal 30A to create document data. The document data may be acquired from the outside of the document-data merging system 100. The document writer designates the document storage folder 12 (ID+Year) and performs an operation of storing the document data in the server apparatus 10. The operation reception unit 33 receives this operation, and the communication unit 31 transmits the document data to the server apparatus 10.

In step S102, the communication unit 11 of the server apparatus 10 receives the document data and stores the document data in the document storage folder 12 (folder identified by ID+Year).

In step S103, when a document registrant distributes the document data, the document registrant connects the document registration terminal 30B to the server apparatus 10 and inputs an operation for requesting a list of document data to the document registration terminal 30B. The acquisition unit 47 of the document registration terminal 30B acquires the list of the document data from the document storage folder 12 of the server apparatus 10 via the communication unit 41 in response to an operation by the document registrant. The request of the list of the document data need not be made only at this timing, and the document registration terminal 30B may communicate with the server apparatus 10 multiple times. For example, a step of separately requesting classification and merging may be added, or a step of acquiring the document data themselves by the document registration terminal 30B may added.

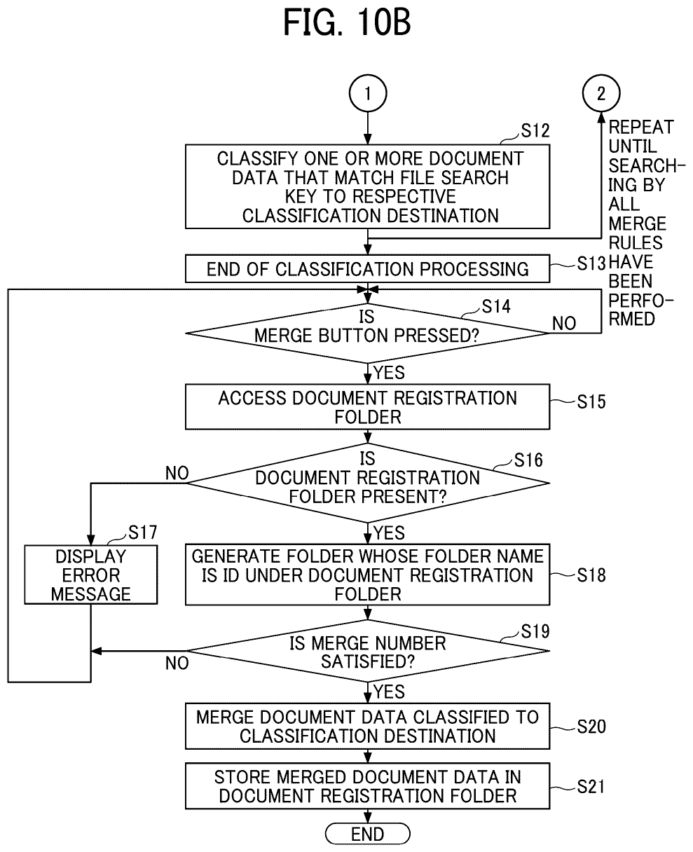

In step S104, the document registration terminal 30B classifies and merges the document data based on the list of the document data. The details of the step S104 are described later with reference to FIGS. 10A and 10B. The merged document data are generated as, for example, a PDF file.

In step S105, the document registrant displays the contents of the merged document data by using the application corresponding to the PDF file, and inputs an operation for printing the merged document data to the document registration terminal 30B. The document registrant and the person who prints the document data may be different. The display of the contents of the document data may not be required. When new document data is stored in the document registration folder 63, the document merge application 9 may automatically execute printing.

In step S106, the printer driver of the document registration terminal 30B generates a print job, and the communication unit 41 transmits the print job to the apparatus 20. Accordingly, the apparatus 20 prints the merged document data.

A flow of processing in which the document registration terminal 30B merges the document data for each category is described with reference to FIGS. 10A and 10B. FIGS. 10A and 10B are flowcharts illustrating the process in which the document registration terminal 30B classifies and merges the document data. A plurality of document data are already stored in the document storage folder 12 of the server apparatus 10. The process illustrated in FIGS. 10A and 10B is started by the document registrant activating the document merge application 9, for example, once a day, once a week, at a predetermined time, on a predetermined day of the week, or on a predetermined date.

In step S1, the document classification unit 44 first reads a setting file. In the setting file, the following two parameters are specified.
(1) a folder path of the document storage folder 12 (a final file path is determined by a combination of the ID and the value of Year designated on the document-data registration screen 200) and (2) a folder path of the document registration folder 63 (known path of the document registration folder 63)

In step S2, the operation reception unit 43 determines whether the search button 203 is pressed. If the determination in step S2 is Yes, the process proceeds to step S3, and if the determination in step S2 is No, the determination in step S2 is repeated.

In step S3, the document classification unit 44 acquires the ID and the value of Year input to the document-data registration screen 200.

In steps S4 to S12, the document classification unit 44 starts the processing of acquiring a list of document data stored in the document storage folder 12.

In step S5, the document classification unit 44 determines the path of the folder using the parameter specified in step S1 and the ID+Year acquired in step S3, and accesses the document storage folder 12.

In step S6, the document classification unit 44 determines whether the document storage folder 12 specified by the path is present. Whether the document storage folder 12 is present is determined by, for example, whether the document storage folder 12 is found in a file system of an operating system (OS).

If the document storage folder 12 is not present, the process proceeds to step S7, and if the document storage folder 12 is present, the process proceeds to step S8.

In step S7, the display control unit 42 displays an error message indicating that the document storage folder 12 is not present on the document-data registration screen 200. The process of steps S4 to S7 is also terminated.

In step S8, the document classification unit 44 starts classification processing of classifying document data for each merge rule.

In step S9, first, the document classification unit 44 searches the document storage folder 12 for document data in accordance with all the file search keys in one merge rule.

In step S10, the determination unit 46 determines whether all the document data whose document type is defined as “required document” in one merge rule have matched the file search keys. Accordingly, it is determined whether all the required documents are prepared for each classification destination.

If even one document data whose document type is defined as “required document” is not present, the process proceeds to step S11, and if all the document data whose document type is defined as “required document” are present, the process proceeds to step S12.

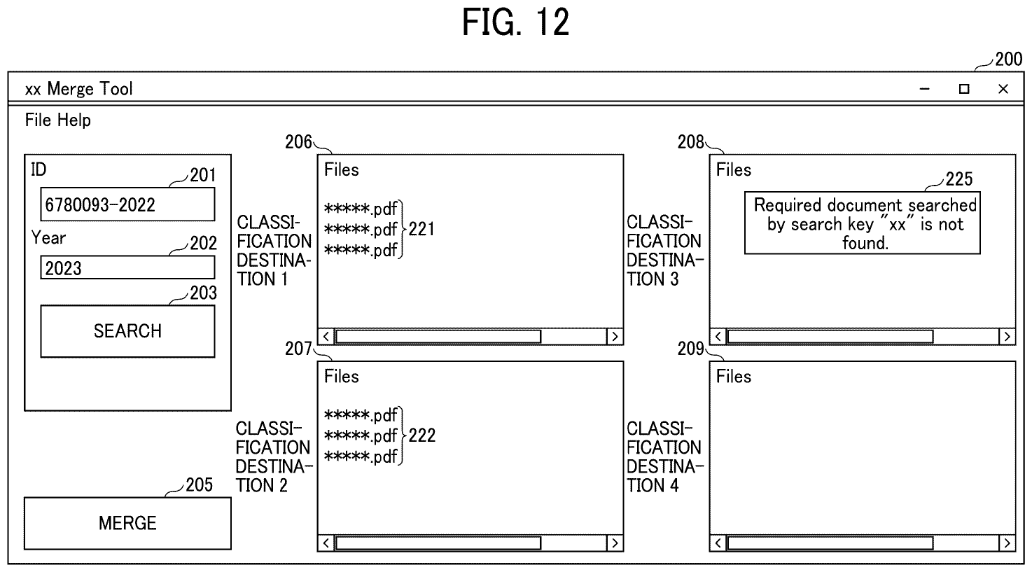

In step S11, the display control unit 42 generates an error message for displaying the document extraction error, and displays the error message on the document-data registration screen 200. An example of the error message is illustrated in FIG. 12. The loop process of steps S9 to S12 is terminated.

In step S12, the document classification unit 44 classifies one or more document data that match the search into each classification destination. The file name of the classified document data is displayed in an area determined by the classification destination name among the first area 206 to the fourth area 209 of the document-data registration screen 200.

The process of steps S9 to S12 is repeatedly performed for each merge rule.

When the document data is extracted in accordance with the file search keys of all the merge rules, the document classifying process is terminated in step S13, and the process proceeds to step S14.

In step S14, the operation reception unit 43 determines whether the merge button 205 is pressed. If the determination in step S14 is Yes, the process proceeds to step S15, and if the determination in step S14 is No, the determination in step S14 is repeated.

In step S15, the merge unit 45 accesses the folder of the document registration folder 63 with the parameter specified in step S1.

In step S16, the merge unit 45 determines whether the folder path of the document registration folder 63 is present. Whether the document registration folder 63 is present is determined by, for example, whether the document storage folder 12 is found in the file system of the OS. The document registration folder 63 at this time may be a higher folder that does not include an ID. The folder containing the ID is generated later.

If the document registration folder 63 is not present, the process proceeds to step S17, and if the document registration folder 63 is present, the process proceeds to step S18.

In step S17, the display control unit 42 causes the display 506 to display an error message indicating an error that the document registration folder 63 is not present. The process returns to step S14.

In step S18, the merge unit 45 generates a folder having the ID as the folder name under the document registration folder 63.

In step S19, the determination unit 46 determines whether the number of classified document data satisfies the merge number determined for each classification destination in the classifying information.

If the number of classified document data does not satisfy the merge number, the process proceeds to step S17. If the number of classified document data satisfies the merge number, the process proceeds to step S20.

In step S20, the merge unit 45 performs a merge process on all the document data classified into each classification destination. In other words, the merging unit 45 merges all the document data displayed in the first area 206 of the document-data registration screen 200 into one document data, merges all the document data displayed in the second area 207 into one document data, merges all the document data displayed in the third area 208 into one document data, and merges all the document data displayed in the fourth area 209 into one document data. Therefore, four merged document data are generated.

In step S21, the merge unit 45 stores each merged document data in a folder having a folder name corresponding to the value of the ID. Then, the process illustrated in FIGS. 10A and 10B ends.

As described above, the document registration terminal 30B classifies the document data stored in the document storage folder 12 into categories or print sizes based on the file names to merge the classified document data.

### Example of Screen

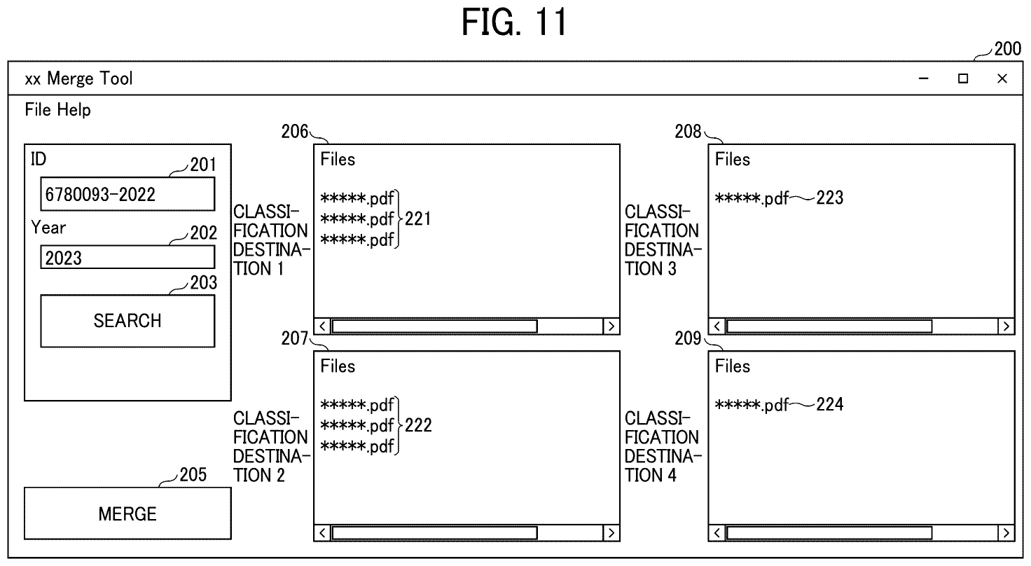

FIG. 11 illustrates an example of the document-data registration screen 200 which displays one or more document data classified into each classification destination. In the following description of FIG. 11, differences from FIG. 11 and FIG. 8 are mainly described. In FIG. 11, one or more document data 221, 222, 223, and 224 searched in accordance with the merge rule are displayed in the first area 206, the second area 207, the third area 208, and the fourth area 209. The three document data 221 in the first area 206 are suitable for the search in accordance with the merge rule in which the classification destination is the classification destination 1. The three document data 222 in the second area 207 are suitable for the search in accordance with the merge rule in which the classification destination is the classification destination 2. The one document data 223 in the third area 208 are suitable for the search in accordance with the merge rule in which the classification destination is the classification destination 3. The one document data 224 in the fourth area 209 are suitable for the search in accordance with the merge rule in which the classification destination is the classification destination 4.

As described above, the document-data registration screen 200 displays the document data to be merged for each classification destination, and the document registrant can confirm the document data to be merged.

FIG. 12 is a diagram illustrating an error message when a required document is not found. In the third area 208 illustrated in FIG. 12, an error message 225 indicating “Required document searched by search key “xx” is not found.” is displayed. The search key included in the error message is a search key with which the required document could not be acquired. The error message 225 is displayed in association with the classification destination in which all the required documents are not found. The error message 225 allows the document registrant to grasp which classification destination the required document is not present and which search key the document data corresponding to is not present.

### Merge Process at Regular Time Intervals

When the document registration terminal 30B performs the merge process at regular time intervals, the document merge application 9 periodically merges and prints the document data accumulated within the predetermined time without the operation of the document registrant.

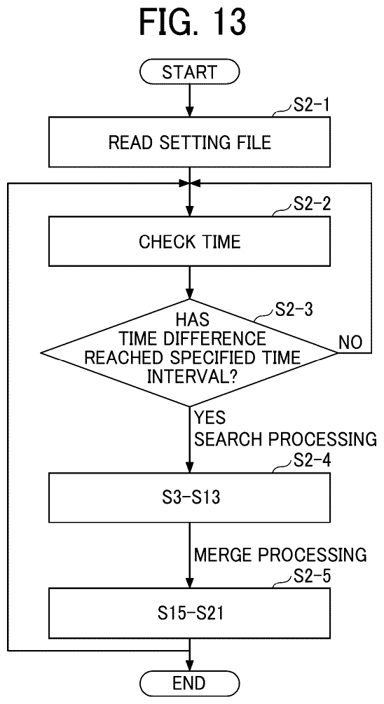

FIG. 13 is a flowchart when the document registration terminal 30B performs the merge process every time a predetermined time elapses. In the following description of FIG. 13, differences from FIG. 13 and FIGS. 10A and 10B may be mainly described.

The process of step S2-1 may be the same as the process of step S1 illustrated in FIG. 10A. In the process illustrated in FIG. 13, it is assumed that the ID and the year are determined in advance.

In step S2-2, the document classification unit 44 acquires the time from a real time clock (RTC) of the document registration terminal 30B or a time server.

In step S2-3, the document classification unit 44 determines whether the difference between the acquired time and the current time reaches the specified time interval (in other words, is equal to or greater than the threshold value). Accordingly, it is determined whether the predetermined time has elapsed.

If the determination in step S2-3 is Yes, the process proceeds to step S2-4, and if the determination in step S2-3 is No, the process returns to step S2-2.

The process of step S2-4 may be the same as the process of steps S3 to S13 illustrated in FIG. 10B. The process of step S2-5 may be the same as the process of steps S15 to S21 illustrated in FIG. 10B.

According to the process illustrated in FIG. 13, the document data accumulated within the predetermined time can be periodically merged and printed without the operation of the document registrant.

### Merge Process at Predetermined Timing

For example, when the print due date and time of the document data is determined, the document registration terminal 30B performs the merge process at a timing corresponding to the print due date and time, so that the document data accumulated before the print due date and time can be merged and printed.

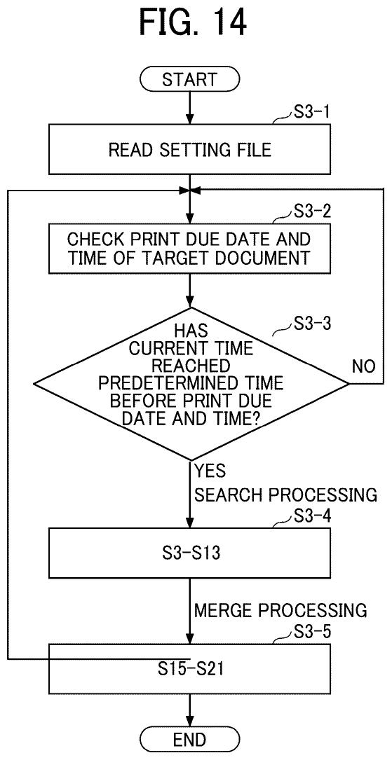

FIG. 14 is a flowchart when the document registration terminal 30B performs a merge process before a print due date and time. In the following description of FIG. 14, differences from FIG. 14 and FIG. 10B may be mainly described.

The process illustrated in S3-1 may be the same as the process illustrated in step S1 illustrated in FIG. 10A. In the process illustrated in FIG. 14, it is assumed that the ID and the year are determined in advance.

In step S3-2, the document classification unit 44 checks the print due date and time of the document data.

The print due date and time may be, for example, a predetermined date and time. The date and time may be a timing that arrives periodically.

In step S3-3, the document classification unit 44 compares the checked print due date and time with the current time, and determines whether the current time reaches a predetermined time before the print due date and time.

If the determination in step S3-3 is Yes, the process proceeds to step S3-4, and if the determination is No, the process returns to step S3-2.

The process illustrated in step S3-4 may be the same as the process illustrated in steps S3 to S13 illustrated in FIG. 10A. The process illustrated in step S3-5 may be the same as the process illustrated in steps S15 to S21 illustrated in FIG. 10B.

As described above, in the present embodiment, a document writer of, for example, a design drawing or a plan document may accumulate generated document data in the document storage folder 12. When the person in charge of document registration operates the document merge application 9 (or may not operate the document merge application 9), the document merge application 9 merges the document data to be integrated into one document data and registers the merged document data in the document registration folder 63. The document registration terminal 30B may automatically print the merged document data or may print the merged document data at any selected timing. The document registration terminal 30B may distribute the merged document data. Therefore, the document-data merging system 100 according to the present embodiment reduces the workload related to the registration and distribution of the document data.

### Second Embodiment

### Document-Data Merging System According to Client-Server Type

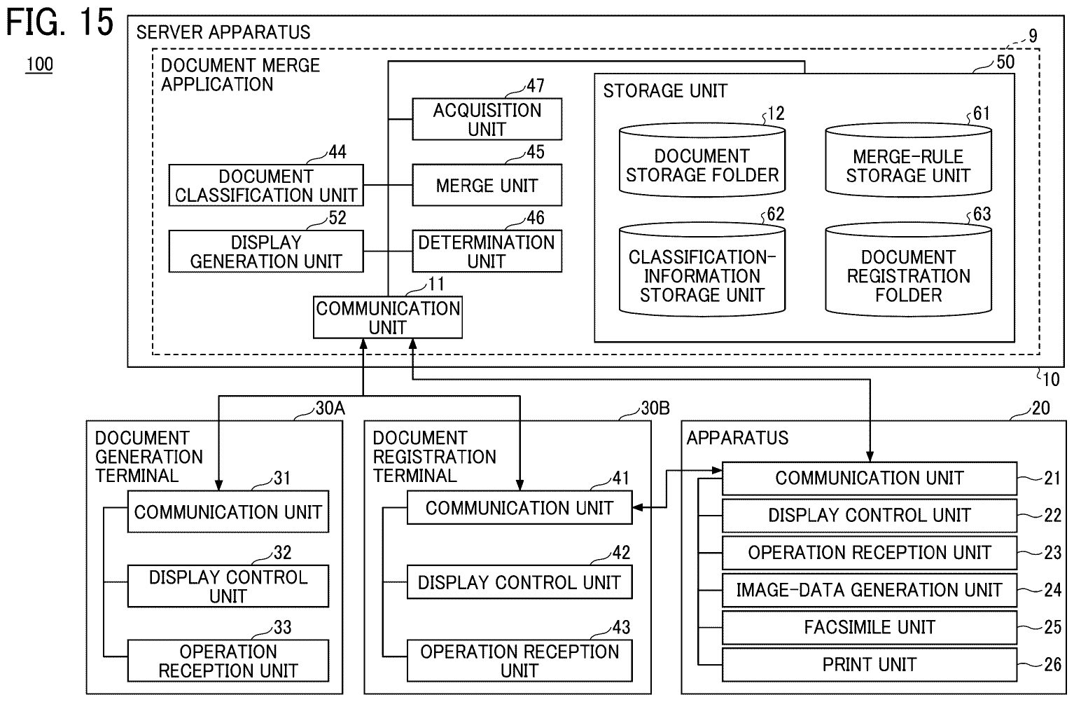

Although the document registration terminal 30B executes the native applications illustrated in, for example, FIG. 5, the document-data merging system 100 may be according to client-server type. FIG. 15 is a functional block diagram of the document-data merging system 100 in the client-server type.

In FIG. 15, the server apparatus 10 includes the communication unit 11, the document classification unit 44, the merge unit 45, the screen generation unit 52, the determination unit 46, the acquisition unit 47, and the storage unit 50. The functions of the communication unit 11, the document classification unit 44, the merge unit 45, the determination unit 46, and the acquisition unit 47 may be the same as the functions illustrated in FIG. 5. The screen generation unit 52 generates screen information for the document registration terminal 30B to display a screen of the web application. The screen information is a program described in HyperText Markup Language (HTML), extensible Markup Language (XML), a scripting language, and Cascading Style Sheet (CSS), or other markup and programming languages. The structure of a web page is mainly specified by HTML, the operation of the web page is defined by a scripting language, and the style of the web page is specified by CSS. The screen generating unit 52 generates the document-data registration screen 200 and provides the document-data registration screen 200 to the document registration terminal 30B as a web application.

The server apparatus 10 includes not only the document storage folder 12 but also a merge-rule storage unit 61, a classification-information storage unit 62, and a document registration folder 63. These configurations may be the same as those illustrated in FIG. 5. Even in the client-server type, the document registration folder 63 may be provided in the document registration terminal 30B.

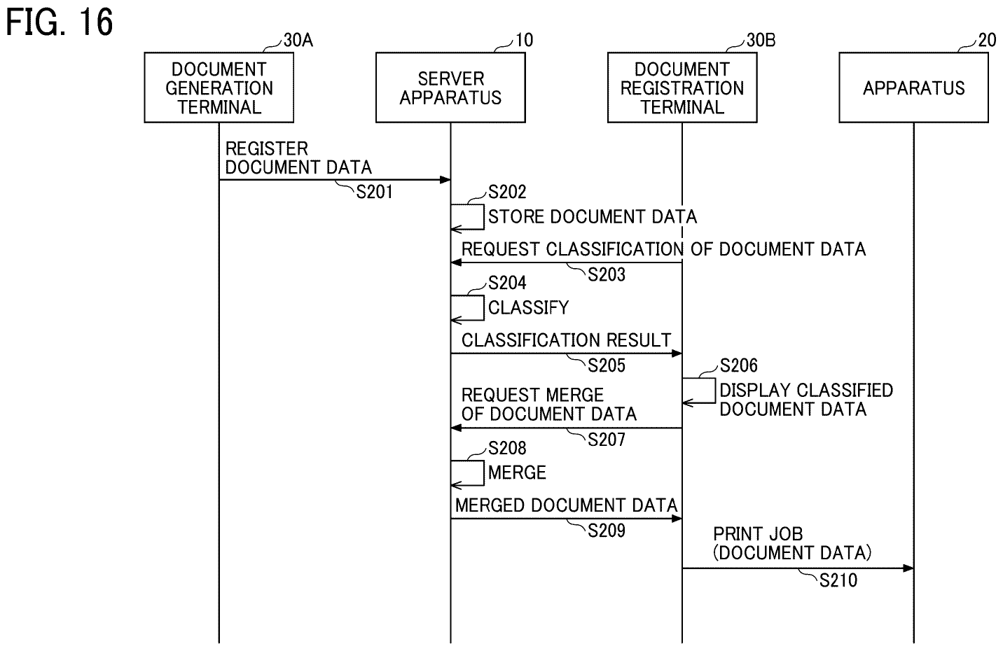

FIG. 16 is a sequence diagram illustrating processing of merging document data by the document-data merging system 100 according to the client-server type.

In step S201, a document writer operates the document generation terminal 30A to create document data. The document data may be acquired from the outside the document-data merging system 100. The document writer designates the document storage folder 12 (ID+Year) and performs an operation of storing the document data in the server apparatus 10. The operation reception unit 33 receives this operation, and the communication unit 31 transmits the document data to the server apparatus 10.

In step S202, the communication unit 11 of the server apparatus 10 receives the document data and stores the document data in the document storage folder 12 (folder identified by ID+Year).

In step S203, when the document registrant distributes the document data, the document registrant connects the document registration terminal 30B to the server apparatus 10 and inputs an operation (pressing of the search button 203) for requesting classification of the document data to the document registration terminal 30B. The communication unit 41 of the document registration terminal 30B transmits the document-data classification request to the server apparatus 10.

In step S204, the communication unit 11 of the server apparatus 10 receives the document-data classification request, and the acquisition unit 47 acquires a plurality of document data from the document storage folder 12. A document classification unit 44 classifies a plurality of document data. The details of the step S204 may be the same as steps S3 to S13 illustrated in FIGS. 10A and 10B.

In step S205, the communication unit 11 of the server apparatus 10 transmits a classified result (the file name of the document data for each classified destination) to the document registration terminal 30B.

In step S206, the communication unit 41 of the document registration terminal 30B receives the classified result, and the display control unit 42 displays the file names of the classified document data in the first area 206 to the fourth area 209.

In step S207, the document registrant inputs an operation to request merging of the document data (pressing of the merge button 205) to the document registration terminal 30B. The communication unit 41 of the document registration terminal 30B transmits the document data merge request to the server apparatus 10.

In step S208, the communication unit 11 of the server apparatus 10 receives the document data merge request, and the merging unit 45 merges the document data classified into the classification destination. The details of the step S208 may be the same as steps S15 to S21 illustrated in FIG. 10B.

In step S209, the merged document data is registered in the document registration folder 63 of the server apparatus 10. The document registrant downloads the merged document data from the server apparatus 10 for printing. Accordingly, the communication unit 11 of the server apparatus 10 transmits the merged document data to the document registration terminal 30B.

In step S210, the communication unit 41 of the document registration terminal 30B receives the merged document data, and the display control unit 42 displays the contents of the document data in response to an operation by the user. The display of the contents of the document data may not be required. The document registrant inputs an operation to print the merged document data to the document registration terminal 30B. The document registrant and the person who prints the document data may be different. The printer driver of the document registration terminal 30B generates a print job, and the communication unit 41 transmits the print job to the apparatus 20. Accordingly, the print unit 26 of the apparatus 20 prints the merged document data.

The user who performs printing may connect the apparatus 20 to the server apparatus 10, download the merged document data from the document registration folder 63, and execute printing.

In the present embodiment, the server apparatus 10 performs classification and merging, but the document registration terminal 30B may perform classification and merging. In this case, the web application to be executed by the document registration terminal 30B includes the functions of classification and merging, and the web application performs classification and merging.

According to the present embodiment, in addition to the effects of the first embodiment, the document registration terminal 30B can request the server apparatus 10 to classify and merge the document data by using the web application. Additionally, since the merged document data is stored in the server apparatus 10, any user can download and print the document data.

The present disclosure is not limited to the above-described embodiments specifically disclosed, and various modifications and changes can be made without departing from the scope of the claims.

For example, in the first embodiment, the document generation terminal 30A may store document data in the document registration terminal 30B. For example, the document generation terminal 30A attaches document data to an e-mail and transmits the e-mail to the document registration terminal 30B.

In the first embodiment, the following methods may be performed as methods for the apparatus 20 to perform pull printing from the document registration terminal 30B. The document registration terminal 30B registers merged document data in a predetermined folder of the server apparatus 10, and the apparatus 20 downloads the merged document data from the folder and prints the document data. Alternatively, a method of installing a web server in the document registration terminal 30B may be performed.

In the configuration example of FIG. 5 and the like, the processing is divided according to the main functions in order to facilitate understanding of the processing by the document registration terminal 30B and the server apparatus 10. No limitation is intended by how the processing units are divided by the unit of processing or by the name. The processing executed by the document registration terminal 30B and the server apparatus 10 may be divided into a greater number of processing units in accordance with the contents of the processing. Alternatively, one unit of processing may be a group of divided processing.

Each of the functions of the above-described embodiments of the present disclosure may be implemented by one or more pieces of processing circuitry. Processing circuitry includes a programmed processor, as a processor includes circuitry. A processing circuit also includes devices such as an application-specific integrated circuit (ASIC), a digital signal processor (DSP), a field programmable gate array (FPGA), and conventional circuit modules arranged to perform the recited functions.

The group of apparatuses or devices described in the embodiments of the present disclosure is one of multiple computing environments to implement the embodiments disclosed in the present disclosure. In some embodiments, the server apparatus 10 includes multiple computing devices such as server clusters. The multiple computing devices are configured to communicate with one another through any type of communication link including a network and a shared memory and perform the processes disclosed herein.

Further, the server apparatus 10 can combine disclosed processing steps in various ways. The components of the server apparatus 10 may be combined into a single apparatus or may be divided into a plurality of apparatuses. One or more of the processes performed by the server apparatus 10 may be performed by the document registration terminal 30B. In the related art, a creator who has created document data needs to register the document data one by one in the system, which imposes a load on the registration operation. For example, when a person in charge distributes document data related to a project to persons concerned in a lump, a workload for registering a plurality of the document data to be collected one by one is large. [0005] A technique for reducing a load on registration work of document data is

provided. [0007] Accordingly, the load on registration work of document data is reduced.

### Aspect 1

A program causes an information processing apparatus to function as an acquisition unit to acquire a plurality of document data from a document storage unit that stores the plurality of document data.

The program causes the information processing apparatus to function as a document classification unit to classify, based on a merge rule, the plurality of document data acquired by the acquisition unit.

The program causes the information processing apparatus to function as a merge unit to merge one or more document data classified by the document classification unit to generate merged document data.

### Aspect 2

In the program according to Aspect 1, the program causes the information processing apparatus to function as an operation reception unit to receive identification information of a task to which the plurality of document data is related.

The merge unit registers the merged document data in a document registration unit in association with the identification information of the task.

### Aspect 3

In the program according to Aspect 1 or 2, the merge rule is a search key for searching for information that can be referred to in the document data by the document classification unit.

### Aspect 4

In the program according to Aspect 3, the information that can be referred to in the document data is a file name of the document data.

### Aspect 5

In the program according to Aspect 3 or 4, the document classification unit classifies, based on a plurality of merge rules having different classification destinations, the plurality of document data into one classification destination for each of the merge rules.

The merge unit merges one or more document data classified into each of a plurality of classification destinations, for each of the plurality of classification destinations, to generate the same number of merged document data as the plurality of classification destinations.

### Aspect 6

In the program according to Aspect 5, a merge number of the document data to be merged is determined for each of the classification destinations.

The program causes the information processing apparatus to function as a decision unit to determine whether the number of one or more document data classified into the classification destination has reached the merge number.

### Aspect 7

In the program according to Aspect 5, the merge rule includes a plurality of search keys including the search key.

Each of the plurality of search keys is associated with whether the document data matching the search key is a required document or an optional document.

The program causes the information processing apparatus to function as a decision unit to determine whether all required documents in one merge rule have been acquired in accordance with the search key.

When the decision unit determines that all the required documents in the one merge rule have been acquired in accordance with the search key, the merge unit merges one or more document data classified by the document classification unit to generate merged document data.

### Aspect 8

In the program according to Aspect 7, the program causes the information processing apparatus to function as a display control unit to display an error message when the document classification unit cannot acquire all the required documents in the one merge rule in accordance with the search key.

### Aspect 9

In the program according to Aspect 8, the display control unit includes, in the error message, the search key for which the required document cannot been acquired.

### Aspect 10

In the program according to Aspect 8, the display control unit displays the error message in association with a classification destination from which all the required documents cannot be acquired in accordance with the search key.

### Aspect 11

In the program according to Aspect 5 or 6, the program causes the information processing apparatus to function as a display control unit to display file names of the plurality of document data classified by the document classification unit for each of the merge rules based on the merge rules in an area associated with the classification destination.

### Aspect 12

In the program according to Aspect 5 or 6, the classification destination is determined according to a category or a print size of the document data.

The document classification unit classifies a plurality of document data having the same category into the same classification destination and classifies a plurality of document data having the same print size into the same classification destination, based on information that can be referred to in the document data.

### Aspect 13

In the program according to Aspect 1, the document classification unit classifies the plurality of document data acquired by the acquisition unit based on a merge rule every time a predetermined time elapses.

The merge unit merges one or more document data classified by the document classification unit to generate the merged document data.

### Aspect 14

In the program according to Aspect 1, the document classification unit classifies the plurality of document data acquired by the acquisition unit based on a merge rule when a predetermined timing arrives.

The merge unit merges one or more document data classified by the document classification unit to generate the merged document data.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A non-transitory recording medium storing a program which, when executed by one or more processors, causes the one or more processors to perform a method comprising:
acquiring a plurality of document data from a memory that stores the plurality of document data;
classifying the plurality of document data based on a merge rule; and
merging two or more document data classified to generate merged document data.

2. The non-transitory recording medium according to claim 1,
wherein the method further includes:
receiving identification information of one or more tasks to which the plurality of document data are related; and
registering the merged document data in another memory in association with the identification information of the task related to two or more document data to be merged.

3. The non-transitory recording medium according to claim 1,
wherein the merge rule is a search key used for searching the document data for information to be referred to.

4. The non-transitory recording medium according to claim 3,
wherein the information to be referred to in the document data is a file name of the document data.

5. The non-transitory recording medium according to claim 3,
wherein the merge rule includes a plurality of merge rules that are different from each other,
wherein the classifying includes classifying the plurality of document data into a plurality of classification destinations corresponding to the plurality of merge rules, and
wherein the merging includes merging two or more document data classified into each of the plurality of classification destinations to generate the same number of merged document data as the number of the plurality of classification destinations.

6. The non-transitory recording medium according to claim 5, wherein the method further includes:
determining a merge number of the two or more document data to be merged for each of the plurality of classification destinations; and
determining whether the number of the two or more document data classified into the classification destination has reached the merge number.

7. The non-transitory recording medium according to claim 5,
wherein the plurality of merge rules include a plurality of search keys including the search key,
wherein each search key is associated with information indicating whether the document data matching the search key is a required document or an optional document,
wherein the method further includes:
determining whether all required documents for one merge rule have been acquired using the search key; and
merging two or more document data classified to generate the merged document data, when the determining determines that all the required documents for the one merge rule have been acquired using the search key.

8. The non-transitory recording medium according to claim 7,
wherein the method further includes displaying an error message when the determining determines that all the required documents for the one merge rule have not been acquired using the search key.

9. The non-transitory recording medium according to claim 8,
wherein the displaying includes displaying the error message including the search key used for acquiring the required documents.

10. The non-transitory recording medium according to claim 8,
wherein the displaying includes displaying the error message in association with the classification destination to which the required documents have been classified.

11. The non-transitory recording medium according to claim 5,
wherein the method further includes displaying file names of the plurality of document data classified to the plurality of classification destinations corresponding to the plurality of merge rules each in an area associated with the classification destination.

12. The non-transitory recording medium according to claim 5, wherein the method further includes:
determining each of the plurality of classification destinations according to a category or a print size of document data, and
the classifying includes classifying the plurality of document data based on the information to be referred to in the document data, such that two or more document data having the same category or the same print size are classified into the same classification destination.

13. The non-transitory recording medium according to claim 1,
wherein the classifying includes classifying the plurality of document data every time a predetermined time elapses.

14. The non-transitory recording medium according to claim 1,
wherein the classifying includes classifying the plurality of document data when a predetermined timing arrives.

15. A document-data merging system comprising:
a server; and
an information processing apparatus communicably connected with the server via a network,
wherein the server includes server circuitry configured to:
acquire a plurality of document data from a memory that stores the plurality of document data;
classify the plurality of document data based on a merge rule; and
merge two or more document data classified to generate merged document data, and
wherein the information processing apparatus includes apparatus circuitry configured to receive the merged document data from the server.

16. A document-data merging method performed by one or more computers, the method comprising:
acquiring a plurality of document data from a memory that stores the plurality of document data;
classifying the plurality of document data based on a merge rule; and
merging two or more document data classified to generate merged document data.
